(19) United States
(12) Patent Application Publication
(10) Pub. No.: US 2015/0219226 A1
(43) Pub. Date: Aug. 6, 2015

(54) FLUID FLOW CONTROLLER AND FILTER ASSEMBLY WITH FLUID FLOW CONTROLLER

(71) Applicant: Fram Group IP, LLC, Lake Forest, IL (US)

(72) Inventors: Gerard W. Bilski, Perrysburg, OH (US); Michael Herald, Maumee, OH (US); Daniel Auxter, Genoa, OH (US); Gary J. Osterfeld, Coldwater, OH (US); John D. Gaither, Olney, IL (US); Zafar Hussain, Perrysburg, OH (US); Jake D. Whitman, Perrysburg, OH (US)

(21) Appl. No.: 14/607,722

(22) Filed: Jan. 28, 2015

Related U.S. Application Data
(60) Provisional application No. 61/935,633, filed on Feb. 4, 2014.

(51) Int. Cl. F16K 15/02; F17D 5/00

(52) U.S. Cl. CPC F16K 15/025; F17D 5/00

(57) ABSTRACT

A filter assembly comprises a housing open at one end and holding a filter element therein and a plate closing the open end of the housing and enclosing the filter element within the housing. The plate includes at least two first inlet openings, at least two second inlet openings, and a central outlet opening. The filter assembly further includes a fluid flow controller disposed between an end of the filter element and the plate. The flow controller includes a relief valve comprising a first portion cooperating with the first inlet openings and a second portion cooperating with the second inlet openings; and biasing means operatively connected to the relief valve and providing resistance to movement of the second portion of the relief valve.

### CROSS-REFERENCE

This application claims the benefit of U.S. Provisional Patent Application No. 61/935,633, filed on Feb. 4, 2014, the entire disclosure of which is incorporated herein.

### BACKGROUND

1. Field of the Disclosure

The present invention relates generally to a fluid filter assembly and, more particularly, to a fluid filter assembly having a fluid flow controller.

2. Background of the Disclosure

Filter assemblies generally include a housing having an open end, a filter element received in the housing, an end plate closing the open end and having inlet and outlet openings therein, and a valve for cooperating with the inlet openings to allow oil to flow into the filter through the inlet openings, but prevent flow of oil in a reverse direction. Prior art filters have included a combination valve having two portions, the first portion for closing the inlet openings to block the flow of oil back out of the inlet openings when the oil is not being circulated and the second portion for opening a bypass opening when the filter media is clogged for returning oil to the engine to keep the engine lubricated even though the filter element is clogged. Such a construction is disclosed in Stanhope et al. U.S. Pat. No. 7,175,761.

The present disclosure improves upon current valves and overcomes disadvantages and deficiencies of such prior art constructions.

### SUMMARY

In an illustrative embodiment, a filter assembly may comprise a housing open at one end and holding a filter element therein and an end plate secured to the housing, closing the open end, and enclosing the filter element within the housing, the end plate including a first inlet opening, a second inlet opening, and an outlet opening. The filter assembly further includes a fluid flow controller disposed between an end of the filter element and the end plate. The fluid flow controller includes a relief valve comprising a first portion cooperating with the first inlet opening, a second portion cooperating with the second inlet opening and extending from the first portion, and a spring operatively connected to the relief valve and providing resistance to movement of the second portion of the relief valve. The fluid flow controller is configured to allow fluid flow through only the first inlet opening when a first differential pressure across the first portion of the relief valve is reached and to allow fluid flow through the second inlet opening when a second differential pressure greater than the first differential pressure is reached.

In any of the embodiments herein, the spring may be at least partially embedded within the relief valve. Further, in any embodiment herein, the spring may include inner and outer rings connected by a plurality of arms, the inner ring may be embedded in a connecting portion between the first and second portions of the relief valve, and the outer ring and the plurality of arms may be embedded within the second portion of the relief valve. Still further, in any of the embodiments herein, each of the plurality of arms may include a first radial segment extending from the inner ring, a second radial segment extending from the outer ring, and an annular segment extending between the first and second radial segments. In any of the embodiments herein, the annular segment may extend through an angle of between about 30 degrees and about 150 degrees.

In any of the embodiments herein, the spring may include a ring and a plurality of tabs extending inwardly from the ring, the ring may be embedded within the first portion of the relief valve, and the tabs may be embedded within the second portion of the relief valve.

In any of the embodiments herein, the filter element may include a filter media wrapped around a core and the core includes a projection extending inwardly therefrom. Still further, in any embodiment herein, the second portion of the relief valve may comprise a first segment that covers the second inlet opening, a second segment that abuts at least a portion of the core, and a groove disposed within the first segment of the second portion of the relief valve. The spring may be compressed between the projection and the first segment of the second portion such that a first end of the spring is disposed within the groove, thereby providing resistance to opening of the first segment of the second portion.

In another illustrative embodiment, a filter assembly may comprise a housing open at one end and holding a filter element therein and a plate closing the open end of the housing and enclosing the filter element within the housing. The plate may include at least two first inlet openings, at least two second inlet openings, and a central outlet opening. The filter assembly may further include a fluid flow controller disposed between an end of the filter element and the plate. The flow controller may include a relief valve comprising a first portion cooperating with the first inlet openings and a second portion cooperating with the second inlet openings; and biasing means operatively connected to the relief valve and providing resistance to movement of the second portion of the relief valve.

In any of the embodiments herein, the biasing means may be in the form of a spring at least partially embedded within the relief valve. In any of the embodiments herein, the spring may include inner and outer rings connected by a plurality of arms and the outer ring and the plurality of arms may be at least partially embedded within the second portion of the relief valve. Still further, in any of the embodiments herein, each of the plurality of arms may include a first radial segment extending from the inner ring, a second radial segment extending from the outer ring, and an annular segment extending between the first and second radial segments. In any embodiment herein, the annular segment may extend through an angle of between about 30 degrees and about 150 degrees.

In any of the embodiments herein, the spring may include a ring and a plurality of tabs extending inwardly from the ring and the tabs may be at least partially embedded within the second portion of the relief valve.

In any of the embodiments herein, the filter element may include a filter media wrapped around a core and the core may include a projection extending inwardly therefrom. Still further, in any embodiment, the second portion of the relief valve may comprise a first segment that covers the second inlet opening, a second segment that abuts at least a portion of the core, and a groove disposed within the first segment of the second portion of the relief valve. The spring may be compressed between the projection and the first segment of the second portion such that a first end of the spring is disposed within the groove, thereby providing resistance to opening of the first segment of the second portion.

In a further illustrative embodiment, a fluid flow controller for a filter assembly may comprise a relief valve including a first portion and a second portion extending from and connected to the first portion. The fluid flow controller may further include a spring having a ring portion disposed within the first portion and a resilient portion disposed within the second portion, wherein the spring may be configured to require a greater differential pressure to move the second portion of the relief valve than is required to move the first portion.

In any of the embodiments herein, the spring may include inner and outer rings connected by a plurality of arms, the inner ring may be embedded in a connecting portion between the first and second portions of the relief valve, and the outer ring and the plurality of arms may be embedded within the second portion of the relief valve. Further, in any of the embodiments herein, each of the plurality of arms may include a first radial segment extending from the inner ring, a second radial segment extending from the outer ring, and an annular segment extending between the first and second radial segments, wherein the annular segment may extend through an angle of between about 30 degrees and about 150 degrees.

In any of the embodiments herein, the spring may include a ring and a plurality of tabs extending inwardly from the ring, the ring may be embedded within the first portion of the relief valve, and the tabs may be embedded within the second portion of the relief valve.

### BRIEF DESCRIPTION OF THE DRAWINGS

FIG. 1 is a cross-sectional view of a filter assembly including a cylindrical shell or housing holding a filter element and including a fluid flow controller for controlling flow of fluid into the housing;

FIG. 2 is an enlarged cross-sectional view of the fluid flow controller of FIG. 1;

FIG. 3 is a top perspective view of the fluid flow controller of FIG. 1 including a relief valve with a portion thereof removed to depict a first embodiment of a spring embedded within the relief valve;

FIG. 4 is a cross-sectional view of the relief valve of FIG. 1 taken generally along the lines 4-4 of FIG. 3;

FIG. 5 is a top plan view of the spring removed from the relief valve of FIG. 3;

FIG. 6 is a top perspective view of the fluid flow controller of FIG. 1 with a portion of the relief valve removed to depict a second embodiment of a spring embedded within the relief valve;

FIG. 7 is a cross-sectional view of the relief valve taken generally along the lines 7-7 of FIG. 6;

FIG. 8 is a top plan view of the spring removed from the relief valve of FIG. 6;

FIG. 9 is a cross-sectional view of a filter assembly similar to the filter assembly of FIG. 1 with a housing thereof removed, wherein the filter assembly includes a fluid flow controller comprising a relief valve and an external spring for controlling flow of fluid into the housing; and

FIG. 10 is an enlarged cross-sectional view of the fluid flow controller of FIG. 9.

Other aspects and advantages of the present invention will become apparent upon consideration of the following detailed description, wherein similar structures have like or similar reference numerals.

### DETAILED DESCRIPTION

The present disclosure is directed to a filter assembly including a fluid flow controller. While the present disclosure may be embodied in many different forms, one specific embodiment is discussed herein with the understanding that the present disclosure is to be considered only as an exemplification of the principles of the disclosure, and it is not intended to limit the disclosure to the embodiment illustrated.

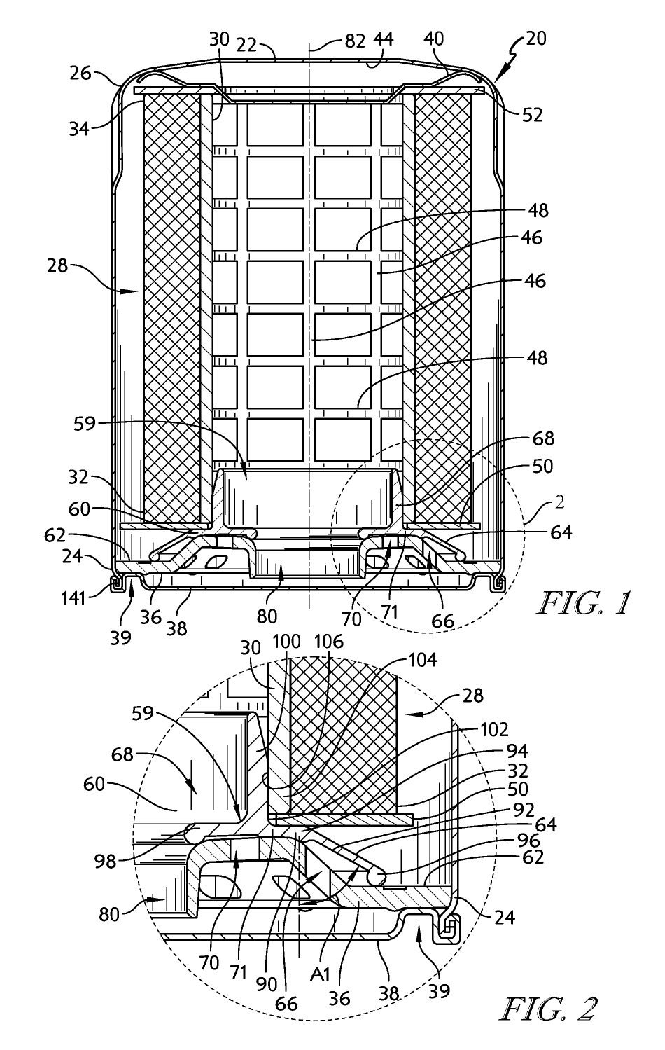

Referring to FIGS. 1 and 2, a filter assembly 20 is depicted as having a generally cup-shaped cylindrical shell or housing 22 that is open at a first or lower open end 24 and closed at a second or upper, opposite end 26. A filter, for example, in the form of a filter element 28 mounted on a core 30, is disposed within the housing 22, wherein the filter element 28 includes a first or lower end 32 positioned adjacent the first end 24 of the housing and a second or upper end 34 adjacent the second end 26 of the housing 22. While a particular filter is disclosed herein, one skilled in the art will understand that the principles of the present disclosure may be applied to any suitable filter assembly having any suitable filter. An end plate 36 is provided in the lower open end 24 of the housing 22 and may include a lid 38 attached thereto. An annular, resilient gasket (not shown) may be received and retained in a recess 39 in the lid 38 for providing a seal between the filter assembly 20 and an engine block (not shown) to which the filter assembly 20 is secured in normal use. Optionally, any other suitable additional or alternative seal may be used. A biasing element 40, for example, a spring, may be provided between the upper end 34 of the filter element 28 and an interior 44 of the housing 22 for biasing the filter element 28 toward the first end 24 of the housing 22. The biasing element 40 may be replaced with any suitable element(s) that bias the filter toward the first end 24 of the housing 22 or may be omitted.

The filter element 28 may include any suitable filter media comprised of, for example, pleated filter material composed of cellulose with some polyester. The core 30, which may be molded from any appropriate material, for example, a glass filled plastic, such as, Nylon, is perforated so as to permit fluid flow therethrough in use. The core 30 may comprise a cage formed by vertically disposed members 46 suitably secured to horizontally disposed members 48, as seen in FIG. 1. The filter media may be formed from a sheet of pleated material joined along the facing ends by a suitable adhesive to form an annular sleeve on the core 30. End caps 50, 52 may be disposed at the bottom and top, respectively, of the filter element 28. The end caps 50, 52 may be fabricated from a suitable composite material, for example, a cellulose/polyester composite. In an illustrative embodiment, the end caps 50, 52 are bonded to the filter media, for example, by ultrasonic welding, to form a seal between the ends of the filter media and the end caps 50, 52 to prevent fluid flow between these elements in use. The end caps 50, 52 may alternatively be bonded to the filter media in any other suitable manner.

The filter element 28 and housing 22 of the filter assembly 20 may be similar to the filter element 28 and housing 22 disclosed in Stanhope et al. U.S. Pat. No. 7,175,761, the disclosure of which is hereby incorporated by reference in its entirety. In other illustrative embodiments, the principles of the present disclosure may be applied to any suitable filter assembly having any suitable housing and/or any suitable filter element.

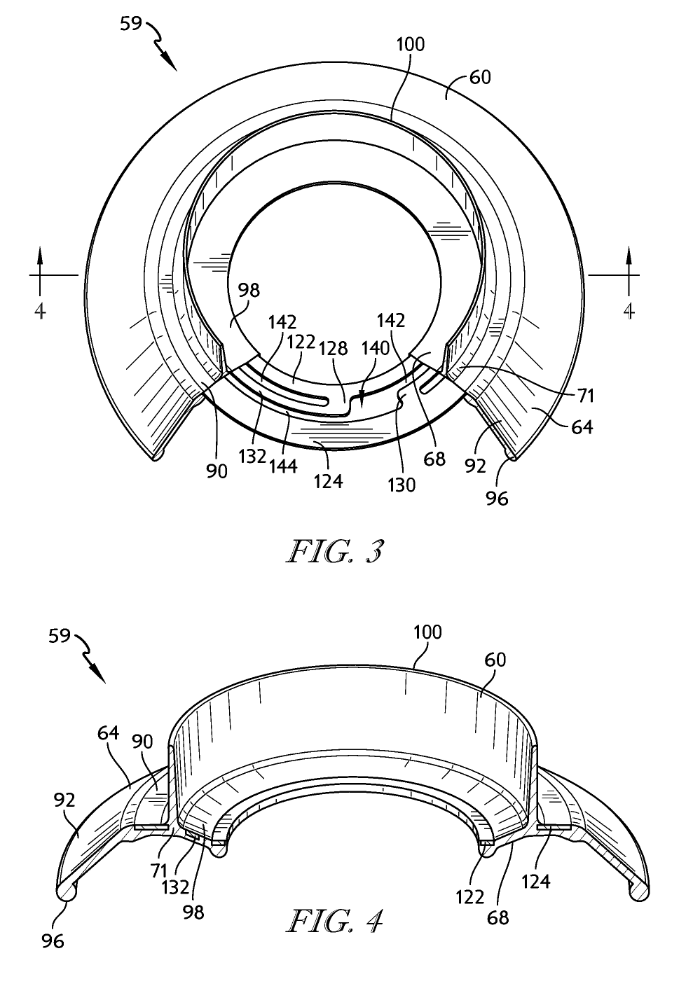

Referring to FIGS. 3-5, a first embodiment of a fluid flow controller 59 is depicted. The fluid flow controller 59 includes a relief valve 60 retained between the lower end 32 (for example, the end cap 50) of the filter element 28 and a top or inner side 62 of the end plate 36. The relief valve 60 includes a first portion 64 for controlling flow through a first inlet opening or openings 66 in the end plate 36 and a second portion 68 for controlling flow through a second inlet opening or openings 70, wherein the second portion 68 is connected to the first portion 64 at a connection point 71. Any suitable number of first inlet openings 66 and/or second inlet openings 70 may be provided.

An outlet opening 80 is provided centrally within the end plate 36. As seen in FIG. 1, the outlet opening 80 may be centrally disposed about a longitudinal axis 82 of the filter assembly 20. While the outlet opening 80 is depicted as being circular in cross-section, the outlet opening 80 may have any other suitable configuration depending on the application for the filter assembly 20. Still optionally, the outlet opening 80 may be oriented in any suitable manner.

Referring to FIGS. 3-5, which show enlarged views of all or portions of the fluid flow controller 59, the first portion 64 is annular and includes a generally horizontal segment 90 that extends from the connection point 71 and an angled segment 92 extending from the generally horizontal segment 90 and disposed at an angle A1 with respect to the generally horizontal segment 90, thereby forming a bend 94 in the first portion 64. In an illustrative embodiment, the generally horizontal segment 90 extends from the connection point 71 and the angled segment 92 extends at the angle A1 with respect to a horizontal plane such that a free end 96 of the angled segment 92 is inclined outwardly and downwardly from the generally horizontal segment 90. The second portion 68 includes an annular inwardly extending segment 98 that is adapted to cooperate with the second inlet openings 70 and an upwardly extending segment 100 that cooperates with the generally horizontal segment 90 of the first portion 64 to form a shoulder 102 that receives a lower end 104 of the core 30 of the filter element 28. The upwardly extending segment 100 is annular and engages an inner surface 106 of the lower end 104 of the core 30 when assembled. The free end 96 of the angled segment 92 and an end of the inwardly extending segment 98 are bulbous to elevate the first portion 64 and the inwardly extending segment 98 to provide a gap between elastomeric surfaces thereof and the end plate 36 to distribute pressure evening across the relief valve 60. The relief valve 60 may be made of rubber, plastic, an elastomeric material, or any other suitable material.

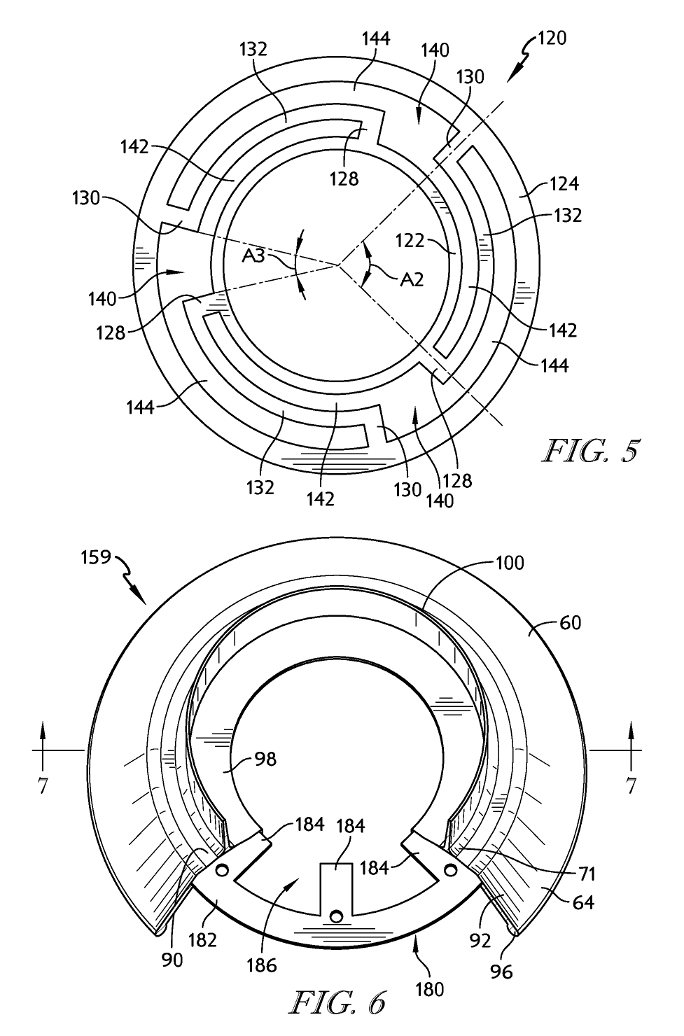

In the illustrative embodiment of FIGS. 3-5, a spring 120 may be embedded within the relief valve 60. The spring 120 is generally planar and is made of a resilient material, such as a thin metal or any other suitable resilient material. Optionally, the spring 120 may be non-planar. As best seen in FIG. 5, the spring 120 includes flat inner and outer rings 122, 124 connected by a number of flat arms 126. While three arms 126 are depicted, any number of arms 126 may be utilized to change the resistance of the spring 120. Each arm includes a first radial segment 128 extending outwardly from the inner ring 122, a second radial segment 130 extending inwardly from the outer ring 124, and an annular segment 132 extending between the first and second radial segments 128, 130. In an illustrative embodiment, the annular segment 132 extends through an angle A2 of about 90 degrees. In other illustrative embodiments, the annular segment 132 may extend through an angle of between about 30 degrees and about 150 degrees. In still alternative illustrative embodiments, the annular segment 132 may extend through an angle of between about 60 degrees and about 120 degrees. While the arms 126 are depicted as including radial segments 128, 130 and an annular segment 132, it is within the scope of the present disclosure to vary the design and shape of the arms 126 and/or include arms of different designs and/or shapes.

Still referring to FIG. 5, elongate openings 140 are formed between the arms 126 and the inner and outer rings 122, 124. Each of the openings 140 includes overlapping inner and outer annular segments 142, 144. In an illustrative embodiment, the inner and outer annular segments 142, 144 overlap for an angle A3 of about 30 degrees, wherein the overlap corresponds to a gap between a first radial segment 128 of one arm 126 and a second radial segment 130 of an adjacent arm 126. In alternative illustrative embodiments, the inner and outer annular segments 142, 144 may overlap for an angle of between about 5 degrees and about 60 degrees. In still further illustrative embodiments, the inner and outer annular segments 142, 144 may overlap for an angle of between about 20 degrees and about 45 degrees.

The spring 120 is at least partially embedded within the relief valve 60, as seen in FIGS. 3 and 4. More particularly, the outer ring 124 of the spring 120 is embedded within the generally horizontal segment 90 of the first portion 64 of the relief valve 60 and the inner ring 122, the radial segments 128, 130, and the annular segments 132 are embedded within the inwardly extending segment 98 of the second portion 68 of the relief valve 60. The outer ring 124 anchors the spring 120 within the relief valve 60 and the inner ring 122 and the arms 126 extend into and provide resistance to movement of the inwardly extending portion 98 of the second portion 68 of the relief valve 60. The resistance of the elastomer of the first portion 64 insures that a pressure necessary to move the first portion 64 and open the first inlet openings 66 is less than a pressure necessary to move the inclined segment of the second portion 68 and open the inlet openings 70. In an illustrative embodiment, the first portion 64 of the relief valve 60 may open the first inlet openings 66 at a minimum opening pressure, for example, on the order of 1 pound per square inch (psi) and the inwardly extending segment 98 of the second portion 68 may open the second inlet openings 70 at a predetermined higher pressure, for example, on the order of 8-10 psi. The properties of the spring 120 (e.g., the number of arms 126, the material, the spring rate, tensile strength, hardness, modulus of elasticity, thickness, or any other spring properties) may be varied to vary the pressure necessary to move the inwardly extending segment 98 and open the openings 70.

The fluid flow controller 59 may be manufactured in any suitable manner. In one embodiment, the spring 120 may be inserted into a mold and rubber and/or another suitable material may be injected into the mold to create the relief valve 60. In this manner, when the injected material sets, the spring 120 will be embedded within the relief valve 60.

The assembly and operation of the filter assembly 20 and the fluid flow controller 59 will now be described. The filter element 28 is assembled with the annular filter media on the core 30 and the end caps 50, 52 secured in place. Assembly of the filter element 28 may occur prior to assembly of the filter assembly 20, for example, the filter element 28 may be purchased from a third party. The spring 40 or other biasing means, if used, is first inserted into the open end of the housing 12 until it seats against the closed end of the housing 22. The filter element 28 is positioned in the housing 22 abutting the spring 40. The fluid flow controller 59 is positioned in the core 30 with the second segment 100 of the second portion 68 of the relief valve 60 engaging the inner surface 106 of the core 30 to help seal fluid flow between the fluid flow controller 59 and the core 30 of the filter element 28. The end plate 36 is inserted to close the open end of the housing 22 and an outer rim of the lid 38 is rolled, for example, with the open end of the housing 22 to form a seal 141 (FIG. 1). Optionally, any other suitable seal may be formed between the lid 38 and the housing 22. Positioning of the end plate 36 in the housing 22 partially compresses the spring 40, whereby, when the parts are assembled, a spring force is applied to the top of the filter element 28 urging the filter element 28 toward the end plate 36. If the spring 40 is used, the spring force will help to clamp the fluid flow controller 59 between the filter element 28 and the end plate 36 and to seal flow between the filter element 28 and the end plate 36. The core 30 will firmly engage the upwardly extending segment 100 of the relief valve 60 and will also engage and bear upon the generally horizontal segment 90 of the first portion 64 of the relief valve 60.

In operation, the filter assembly 20 is spun onto a stud on the engine block, which engages threads in the central outlet opening 80 in the end plate 36, and is secured in place. The gasket will engage the engine block and preclude fluid flow between the engine block and the filter assembly 20. While a particular gasket and lid are described, any suitable gasket and lid configurations may be utilized with the principles of the present application. When the engine is started, fluid, usually oil, will enter the filter assembly 28 through the first inlet openings 66. Slight pressure will move the first portion 64 of the relief valve 60 away from the first inlet openings 66 and oil will flow through the first inlet openings 66, the filter media of the filter element 28, and will be discharged through the central outlet opening 80 for return to the engine. When the engine is turned off, the first portion 64 of the relief valve 60 will close the first inlet openings 66 and prevent return of oil in the filter assembly 20 to the engine. As the filter media clogs during normal operation, differential pressure will build across the inwardly extending segment 98 and, upon attainment of a predetermined pressure, for example, on the order of between about 8 and about 10 psi in an illustrative embodiment, the inwardly extending segment 98 of the second portion 68 of the relief valve 60 will open and permit oil to flow through the second inlet openings 70 and back to the engine, thereby bypassing the filter media of the filter element 28. In other words, during periods of time when high differential pressure exists across the filter media, due to cold thick oil or high contaminant loading of the filter media, for example, the oil will travel through the second inlet openings 70 and open the inwardly extending segment 98 of the second portion 68 of the relief valve 60 to permit oil to bypass the filter media and exit the filter assembly 20 through the central outlet opening 80 for return to the engine.

During operation, the spring 120 provides the desired amount of predetermined resistance to moving the inwardly extending segment 98 and opening the second inlet openings 70. More particularly, the spring 120 is designed with a particular resistance value (based on a spring rate, tensile strength, hardness, modulus of elasticity, thickness, number of arms, distance between arms, and other spring properties), wherein the resistance value is overcome upon attainment of the predetermined pressure in the housing (for example, between about 8 and about 10 psi). The predetermined pressure, and thus the necessary resistance valve of the inwardly extending segment 98 may be different for different filter assemblies and/or applications. The spring 120 is easily customizable for these different applications and provides a more precise resistance value, thereby providing more control over the flow of fluid through the second inlet openings 70.

A further embodiment of a fluid flow controller 159 for use with, for example, the filter assembly 20 of FIGS. 1 and 2, is depicted in FIGS. 6-8. The fluid flow controller 159 includes a relief valve 60 that is identical to the relief valve of FIGS. 3-5. The elements of the relief valve 60 will, therefore, not be described in detail and will include the same reference numerals. The fluid flow controller 159 further includes a spring 180 embedded within the relief valve 60. The spring 180 is generally planar and is made of a resilient material, such as a thin metal or any other suitable resilient material. As best seen in FIG. 8, the spring 180 includes a flat ring 182 with a plurality of inwardly extending radial tabs 184. While eight radial tabs 184 are depicted, any suitable number of radial tabs 184 may be utilized. A central opening 186 is formed by the ring 182 and the radial tabs 184. An aperture 185 may be disposed in a base of each radial tab 184 adjacent or at a point where the tab 184 is attached to the flat ring 182. The apertures 185 may be used to vary a spring rate of the tabs 184.

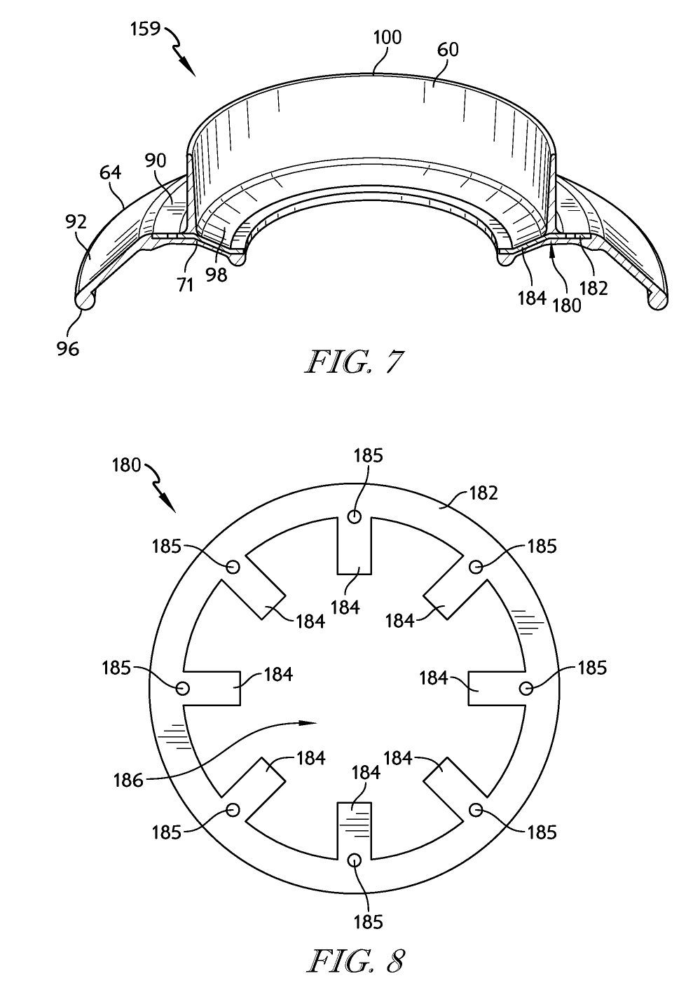

The spring 180 is embedded within the relief valve 60, as seen in FIGS. 6 and 7. More particularly, the ring 182 of the spring 180 is embedded within the generally horizontal segment 90 of the first portion 64 of the relief valve 60 and the tabs 184 extend inwardly from the generally horizontal segment 90 into the inwardly extending segment 98 of the second portion 68 of the relief valve 60. The ring 182 anchors the spring 180 within the relief valve 60 and the tabs 184 extend into and provide resistance to movement of the inwardly extending portion 98 of the second portion 68 of the relief valve 60. The resistance of the elastomer of the first portion 64 insures that a pressure necessary to move the first portion 64 and open the first inlet openings 66 is less than a pressure necessary to move the inclined segment of the second portion 68 and open the inlet openings 70. In an illustrative embodiment, the first portion 64 of the relief valve 60 may open the first inlet openings 66 at a minimum opening pressure, for example, on the order of 1 psi and the inwardly extending segment 98 of the second portion 68 may open the second inlet openings 70 at a predetermined higher pressure, for example, on the order of between about 8 and about 10 psi. The properties of the spring 180 (e.g., the number of arms 126, the material, the spring rate, tensile strength, hardness, modulus of elasticity, thickness, or any other spring properties) may be varied to vary the pressure necessary to move the inwardly extending segment 98 and open the openings 70.

The fluid flow controller 159 may be manufactured in any suitable manner. In one embodiment, the spring 180 may be inserted into a mold and rubber and/or another suitable material may be injected into the mold to create the relief valve 60. In this manner, when the injected material sets, the spring 180 will be embedded within the relief valve 60.

The fluid flow controller 159 operates in the same manner as described above with respect to the fluid flow controller 59 of FIGS. 3-5. In particular, during operation, the spring 180 provides the desired amount of predetermined resistance to moving the inwardly extending segment 98 of the second portion 68 of the relief valve 60 to open the second inlet openings 70. More particularly, the spring 180 is designed with a particular resistance value (based on a spring rate, thickness of ring, tensile strength, hardness, modulus of elasticity, number of tabs, thickness of tabs, width of tabs, length of tabs, and other spring properties), wherein the resistance valve is overcome upon attainment of the predetermined pressure in the housing (for example, between about 8 and about 10 psi). The predetermined pressure, and thus the resistance valve of the inwardly extending segment 98 may be different for different filter assemblies and/or applications. The spring 120 is easily customizable for these different applications and provides a more precise resistance value, thereby providing more control over fluid flow through the second inlet openings 70.

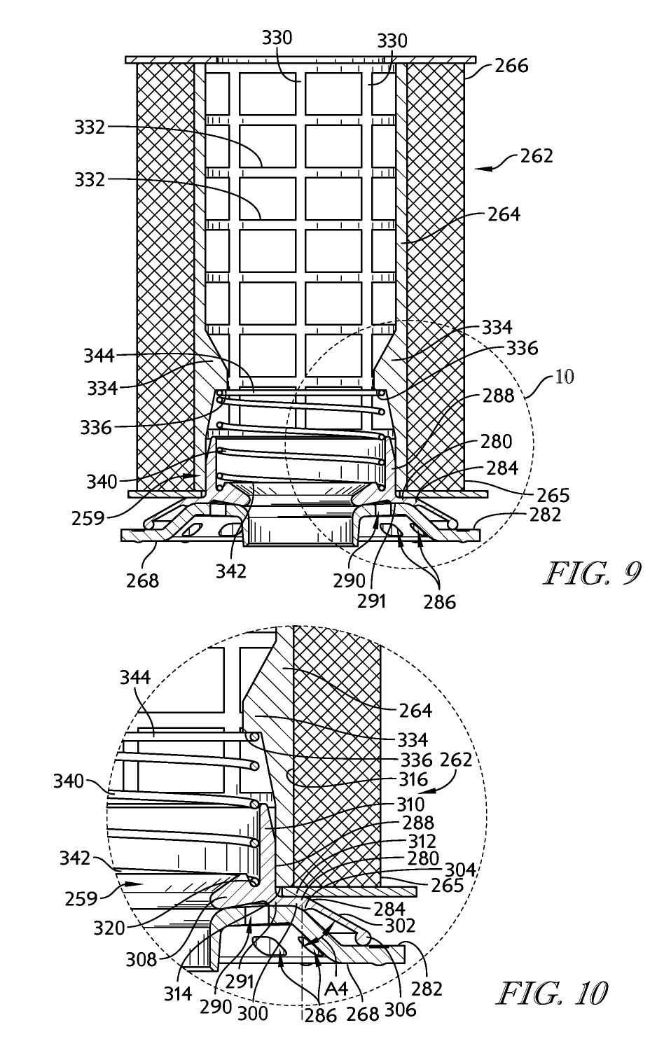

A further embodiment of a fluid flow controller 259 is depicted in FIGS. 9 and 10. The fluid flow controller 259 may be utilized with a filter assembly similar to the filter assembly of FIGS. 1 and 2. Only portions of the filter assembly are shown in FIGS. 9 and 10, it being understood that omitted portions of the filter assembly may be similar to those described with respect to FIGS. 1 and 2. In particular, the filter assembly includes a filter element 262 mounted on a core 264, both of which are disposed within a housing (not shown) of the filter assembly. The filter element 262 includes a first or lower end 265 and a second or upper end 266. The filter element 262 and core 264 may be similar to those described with respect to the filter assembly 20 of FIGS. 1 and 2. While a particular filter is disclosed herein, one skilled in the art will understand that the principles of the present disclosure may be applied to filter assemblies having any suitable filter. An end plate 268 is provided in an open end of the housing.

The fluid flow controller 259 includes a relief valve 280 retained between the lower end 265 of the filter element 262 and a top or inner side 282 of the end plate 268. The relief valve 280 includes a first portion 284 for controlling flow through a first inlet opening or openings 286 in the end plate 268 and a second portion 288 for controlling flow through a second inlet opening or openings 290, wherein the second portion 288 is connected to the first portion 284 at a connection point 291. Any suitable number of first inlet openings 286 and/or second inlet openings 290 may be provided.

As best seen in FIG. 10, the first portion 284 of the relief valve 280 is annular and includes a generally horizontal segment 300 that extends from the connection point 291 and an inclined segment 302 extending from the generally horizontal segment 300 and disposed at an angle A4 with respect to the generally horizontal segment 300, thereby forming a bend 304 in the first portion 284. In an illustrative embodiment, the generally horizontal segment 300 extends from the connection point 291 and the inclined segment 302 extends at the angle A1 with respect to a horizontal plane through the horizontal segment 300 such that a free end 306 of the inclined segment 302 is inclined outwardly and downwardly from the generally horizontal segment 300. The second portion 288 includes a bulbous annular inwardly extending segment 308 that is adapted to cooperate with the second inlet openings 290 and an upwardly extending segment 310 that cooperates with the first, horizontal segment 300 of the first portion 284 to form a shoulder 312 that receives a lower end 314 of the core 264 of the filter element 262. The upwardly extending segment 310 is annular and engages an inner surface 316 of the lower end 314 of the core 264 when assembled. An annular groove 320 is disposed in an upper surface of the inwardly extending segment 308 of the second portion 288 of the relief valve 280.

The core 264 may comprise a cage formed by vertically disposed members 330 suitably secured to horizontally disposed members 332, as seen in FIG. 9. At least two projections 334 extend inwardly from the core 264. While discrete projections are shown and described, a single continuous projection or any number of discrete projections may alternatively be used. Each of the projections 334 includes a downwardly-facing (toward the open end of the filter assembly) ledge 336. The fluid flow controller 259 further includes a spring 340 having a first end 342 disposed within the annular groove 320 in the upper surface of the inwardly extending segment 308 and a second end 344 that abuts and is held in place by the downwardly-facing ledges 336. In this manner, the spring 340 biases the second portion 288 of the relief valve 280 in a closed position until the resistance of the spring 340 is overcome, thereby allowing fluid flow through the second inlet openings 290.

The fluid flow controller 259 operates in the same manner as described above with respect to the fluid flow controller 59 of FIGS. 3-5. In particular, during operation, the spring 340 provides the desired amount of predetermined resistance to movement of the inwardly extending segment 308 and opening of the second inlet openings 290. More particularly, the spring 340 is designed with a particular resistance valve (based on a spring rate, tensile strength, hardness, modulus of elasticity, thickness, and other spring properties), wherein the resistance valve is overcome upon attainment of the predetermined pressure in the housing (for example, between about 8 and about 10 psi). The predetermined pressure, and thus the resistance valve of the inwardly extending segment 308 may be different for different filter assemblies and/or applications. The spring 120 is easily customizable for these different applications and provides a more precise resistance value, thereby providing more control over fluid flow through the second inlet openings 290.

In any of the embodiments herein, a resistance or load on the spring when assembled in the filter may be determined by multiplying a surface area of the relief valve that is exposed to a differential pressure across it times a predetermined relief valve opening pressure. For example, if an area under the spring is approximately 1 square inch and a predetermined valve opening pressure is 20 pounds per square inch (psi), the spring load would be 20 pounds.

While directional terminology, such as upper, lower, top, bottom, etc. is used throughout the present application, such terminology is not intended to limit the disclosure. Such terminology is only used for purposes of describing the various features and components in relation to one another. While certain illustrative embodiments have been described in detail in the figures and the foregoing description, such an illustration and description is to be considered as exemplary and not restrictive in character, it being understood that only illustrative embodiments have been shown and described and that all changes and modifications that come within the spirit of the disclosure are desired to be protected. There are a plurality of advantages of the present disclosure arising from the various features of the apparatus, systems, and methods described herein. It will be noted that alternative embodiments of the apparatus, systems, and methods of the present disclosure may not include all of the features described yet still benefit from at least some of the advantages of such features. Those of ordinary skill in the art may readily devise their own implementations of the apparatus, systems, and methods that incorporate one or more of the features of the present disclosure.

We claim:

1. A filter assembly comprising:
a housing open at one end and holding a filter element therein;
an end plate secured to the housing, closing the open end, and enclosing the filter element within the housing, the end plate including a first inlet opening, a second inlet opening, and an outlet opening;
a fluid flow controller disposed between an end of the filter element and the end plate, the fluid flow controller comprising:
a relief valve including
a first portion cooperating with the first inlet opening; and
a second portion cooperating with the second inlet opening and extending from the first portion; and
a spring operatively connected to the relief valve and providing resistance to movement of the second portion of the relief valve;
wherein the fluid flow controller is configured to allow fluid flow through only the first inlet opening when a first differential pressure across the first portion of the relief valve is reached and to allow fluid flow through the second inlet opening when a second differential pressure greater than the first differential pressure within the housing is reached.

2. The filter assembly of claim 1, wherein the spring is at least partially embedded within the relief valve.

3. The filter assembly of claim 2, wherein the spring includes inner and outer rings connected by a plurality of arms, the inner ring is embedded in a connecting portion between the first and second portions of the relief valve, and the outer ring and the plurality of arms are embedded within the second portion of the relief valve.

4. The filter assembly of claim 3, wherein each of the plurality of arms includes a first radial segment extending from the inner ring, a second radial segment extending from the outer ring, and an annular segment extending between the first and second radial segments.

5. The filter assembly of claim 4, wherein the annular segment extends through an angle of between about 30 degrees and about 150 degrees.

6. The filter assembly of claim 2, wherein the spring includes a ring and a plurality of tabs extending inwardly from the ring, the ring is embedded within the first portion of the relief valve, and the tabs are embedded within the second portion of the relief valve.

7. The filter assembly of claim 1, wherein the filter element includes a filter media wrapped around a core and the core includes a projection extending inwardly therefrom.

8. The filter assembly of claim 7, wherein the second portion of the relief valve comprises:
a first segment that covers the second inlet opening;
a second segment that abuts at least a portion of the core; and
a groove disposed within the first segment of the second portion of the relief valve;
wherein the spring is compressed between the projection and the first segment of the second portion such that a first end of the spring is disposed within the groove, thereby providing resistance to opening of the first segment of the second portion.

9. A filter assembly comprising:
a housing open at one end and holding a filter element therein;
a plate closing the open end of the housing and enclosing the filter element within the housing, the plate including at least two first inlet openings, at least two second inlet openings, and a central outlet opening;
a fluid flow controller disposed between an end of the filter element and the plate, the fluid flow controller comprising:
a relief valve including
a first portion cooperating with the first inlet openings; and
a second portion cooperating with the second inlet openings; and
biasing means operatively connected to the relief valve and providing resistance to movement of the second portion of the relief valve.

10. The filter assembly of claim 9, wherein the biasing means is in the form of a spring at least partially embedded within the relief valve.

11. The filter assembly of claim 10, wherein the spring includes inner and outer rings connected by a plurality of arms and the outer ring and the plurality of arms are at least partially embedded within the second portion of the relief valve.

12. The filter assembly of claim 10, wherein each of the plurality of arms includes a first radial segment extending from the inner ring, a second radial segment extending from the outer ring, and an annular segment extending between the first and second radial segments.

13. The filter assembly of claim 12, wherein the annular segment extends through an angle of between about 30 degrees and about 150 degrees.

14. The filter assembly of claim 10, wherein the spring includes a ring and a plurality of tabs extending inwardly from the ring and the tabs are at least partially embedded within the second portion of the relief valve.

15. The filter assembly of claim 9, wherein the filter element includes a filter media wrapped around a core and the core includes a projection extending inwardly therefrom.

16. The filter assembly of claim 15, wherein the second portion of the relief valve comprises:
a first segment that covers the second inlet opening;
a second segment that abuts at least a portion of the core; and
a groove disposed within the first segment of the second portion of the relief valve;
wherein the biasing means is a spring compressed between the projection and the first segment of the second portion such that a first end of the spring is disposed within the groove, thereby providing resistance to opening of the first segment of the second portion.

17. A fluid flow controller for a filter assembly, the fluid flow controller comprising:
a relief valve including a first portion and a second portion extending from and connected to the first portion; and
a spring having a ring portion disposed within the first portion and a resilient portion disposed within the second portion, wherein the spring is configured to require a greater pressure to move the second portion of the relief valve than is required to move the first portion.

18. The fluid flow controller of claim 17, wherein the spring includes inner and outer rings connected by a plurality of arms, the inner ring is embedded in a connecting portion between the first and second portions of the relief valve, and the outer ring and the plurality of arms are embedded within the second portion of the relief valve.

19. The fluid flow controller of claim 18, wherein each of the plurality of arms includes a first radial segment extending from the inner ring, a second radial segment extending from the outer ring, and an annular segment extending between the first and second radial segments, wherein the annular segment extends through an angle of between about 30 degrees and about 150 degrees.

20. The fluid flow controller of claim 17, wherein the spring includes a ring and a plurality of tabs extending inwardly from the ring, the ring is embedded within the first portion of the relief valve, and the tabs are embedded within the second portion of the relief valve.
